(19) United States
(12) Patent Application Publication
(10) Pub. No.: US 2025/0156323 A1
(43) Pub. Date: May 15, 2025

(54) Performant Data Caching

(71) Applicant: Textron Aviation Inc., Wichita, KS (US)

(72) Inventors: Adam Blake Wolfe, Bentley, KS (US); Haines Todd, Derby, KS (US); Mark Christopher Hansen, Wichita, KS (US)

(21) Appl. No.: 18/936,562

(22) Filed: Nov. 4, 2024

Related U.S. Application Data
(60) Provisional application No. 63/597,650, filed on Nov. 9, 2023.

(51) Int. Cl. G06F 12/0802; B64D 45/00

(52) U.S. Cl. CPC G06F 12/0802; B64D 45/00; G06F 2212/173; G06F 2212/604

(57) ABSTRACT

Systems and methods are disclosed for providing performant, pre-initialization data caching for capturing faults during aircraft recording system startup and writing to one or more local caches an aircraft recording system (ARS) device. One or more candidate input parameter values are captured upon power up of the aircraft recording system, the one or more candidate input parameter values associated with one or more aircraft input parameters corresponding to one or more aircraft system controls. The one or more candidate input parameter values may not have been capable of being captured prior to a full aircraft recording system initialization. An external embedded data processing system is initialized, and upon successful initialization locally cached pre-initialization aircraft data is retrieved and stored in combination with subsequently-acquired aircraft data. The one or more candidate input parameter values may be one or more fault conditions associated with the aircraft.

### CROSS-REFERENCE TO RELATED APPLICATIONS

This application claims the benefit of U.S. Provisional Patent Application No. 63/597,650, filed Nov. 9, 2023, the entire contents thereof are herein incorporated by reference.

### BACKGROUND

### 1. Field

Embodiments of the invention relate generally to performant data caching, and more specifically to systems and methods for capturing important data such as faults during initial system start-up by writing certain data to a local cache and transmitting such data to one or more receiving systems once an initialization process for an external embedded data processing system is complete.

### 2. Related Art

Various methods of data caching are known. For example, U.S. Patent Application No. 2012/0303942 to Peacock describes systems and methods for storing data in a cache based on whether a system requesting the data is currently booting. However, such methods involve caching data associated with initialization of a primary computer, while the primary computer is going through a bootstrap process. U.S. Patent Application No. 2010/0306522 to Wang describes systems and methods for accessing user level data (e.g., faults) during a computer system boot process. The methods described in Wang describe accessing user-level data during the boot process, wherein the associated users are users of the primary computer. U.S. Patent Application No. 2003/0142561 to Mason et al. describes systems and methods for saving data during an initial boot sequence in non-volatile memory for future boot processes to improve the efficiency of future boot processes, which similarly involves the concept of accessing user level data during the boot process. U.S. Pat. No. 10,353,829 to Butcher et al. describes systems and methods for controlling the transmission of data from cache across several chipsets. Specifically, the cache controller controls the flow of data from external I/O devices to the processor (i.e. computer). Butcher does not explicitly disclose the caching of fault data during the boot process, much less fault data associated with a separate system which would subsequently be monitored by a primary computer system. Butcher describes controlling a flow of information from a cache to a processor where one of the criteria is the “age” of the data, however nothing in Butcher teaches or suggests pre-initialization data caching of parameters, whose values could not be observed or preserved prior to initialization of a primary monitoring computer system.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention may be apparent from the following detailed description of the embodiments and the accompanying drawing figures.

In particular, an embodiment includes an aircraft recording system device providing performant data caching for capturing events during aircraft recording system startup and writing to one or more local caches, the aircraft recording system device comprising: an aircraft recording system operatively coupled to a data caching interface, wherein the aircraft recording system captures events upon power up that would otherwise be lost during a full aircraft recording system initialization, one or more data acquisition endpoints associated with the aircraft recording system, capable of locally caching pre-initialization aircraft data within a pre-initialization acquisition period, and an external embedded data processing system adapted to retrieve, read, and store the locally cached pre-initialization aircraft data in combination with subsequently-acquired aircraft data.

Another embodiment includes a method for providing performant, pre-initialization data caching for capturing faults during aircraft recording system startup and writing to one or more local caches an aircraft recording system device, the method comprising: capturing one or more candidate input parameter values upon power up of the aircraft recording system, the one or more candidate input parameter values associated with one or more aircraft input parameters corresponding to one or more aircraft system controls, wherein the one or more candidate input parameter values could not be captured prior to a full aircraft recording system initialization, initializing an external embedded data processing system, retrieving locally cached pre-initialization aircraft data, and storing the locally cached pre-initialization aircraft data in combination with subsequently-acquired aircraft data.

Yet another embodiment includes one or more non-transitory computer-readable media storing computer-executable instructions that, when executed by a processor, perform a method for providing performant, pre-initialization data caching for capturing faults during aircraft recording system startup and writing to one or more local caches an aircraft recording system (ARS) device, the method comprising: capturing one or more candidate input parameter values upon power up of the aircraft recording system, the one or more candidate input parameter values associated with one or more aircraft input parameters corresponding to one or more aircraft system controls, wherein the one or more candidate input parameter values could not be captured prior to a full aircraft recording system initialization, initializing an external embedded data processing system, retrieve locally cached pre-initialization aircraft data, acquiring subsequently-acquired aircraft data, and storing the locally cached pre-initialization aircraft data in combination with the subsequently-acquired aircraft data.

### BRIEF DESCRIPTION OF THE DRAWING FIGURES

Embodiments of the invention are described in detail below with reference to the attached drawing figures, wherein:

FIG. 1A depicts a block diagram for providing a prior art avionics diagnostics network;

FIG. 1B depicts a block diagram illustrating an avionics diagnostics network, in an embodiment;

FIG. 2 depicts an architectural block diagram illustrating a microcontroller-based embodiment of a data collection interface;

FIG. 3 depicts another architectural block diagram illustrating an example of mechanisms for collecting avionics data in a scalable manner;

FIG. 4 depicts a flow diagram illustrating a performant data caching method, in an embodiment; and

FIG. 5 is an aircraft data recording flow diagram illustrating the flow of aircraft data via an aircraft data recording system that utilizes performant data caching.

The drawing figures do not limit the invention to the specific embodiments disclosed and described herein. The drawings are not necessarily to scale, emphasis instead being placed upon clearly illustrating the principles of the invention.

### DETAILED DESCRIPTION

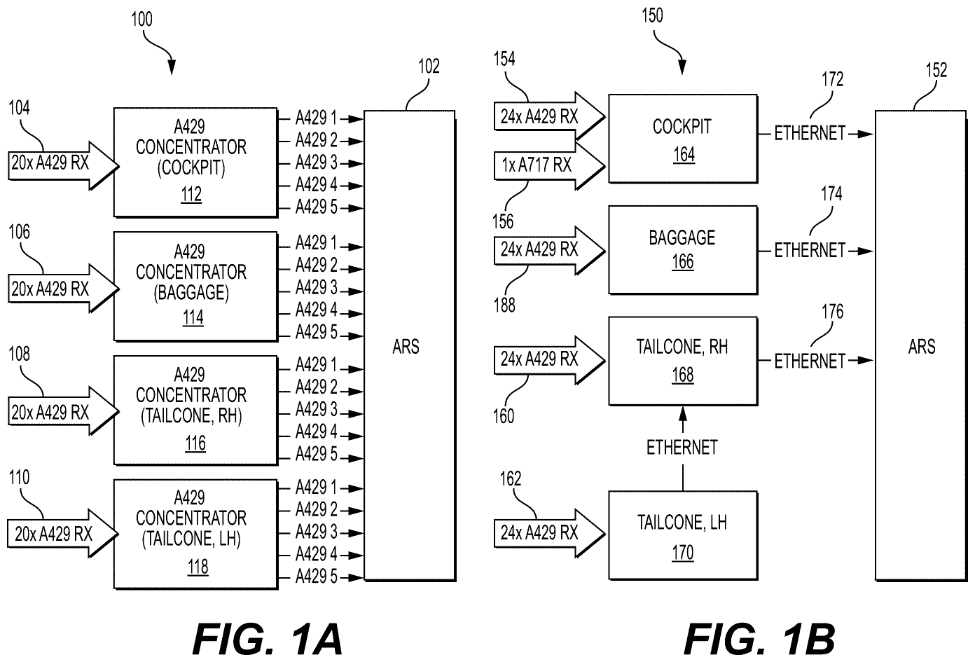

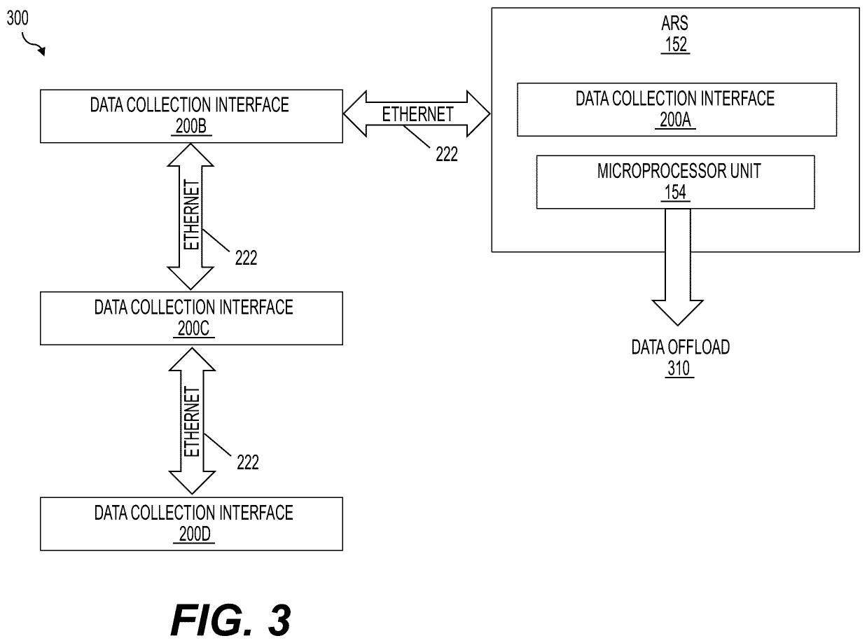

FIG. 1A depicts a block diagram for providing a prior art avionics diagnostics network 100. FIG. 1B depicts a block diagram illustrating an avionics diagnostics network 150, in an embodiment. Aircraft recording system (ARS) units 102 and 152 consistent with the present teachings relate to data acquisition and recording systems designed to be installed in aircraft such as commercial and/or general aviation aircraft. ARS unit 102 may receive and record data from ARINC 429 data buses for retrieval and analysis, such as post-flight retrieval and analysis, for example via avionics data concentrators (or data acquisition endpoints) 112 through 118. ARS unit 152 may receive and record data from ARINC 429, ARINC 717, (controller area network) CAN, and other data buses (e.g., using proprietary protocols) for data retrieval and analysis, such as post-flight retrieval and analysis, for example via avionics data collectors 164 through 170, described below. ARS 152 comprises a microprocessor unit having a non-transitory memory configured for storing received data and a processor configured for processing software instructions, as further described below in connection with FIG. 3. Stored data may be retrieved from an ARS 102, 152 via a removable mass storage module; downloaded on-aircraft via a network connection, such as wirelessly through 802.11 WiFi; wirelessly through LTE or GSM cellular connection; wirelessly through the Iridium satellite constellation, or through a wired transport mechanism such as universal serial bus (USB). Frequently, such an ARS recording unit would be intended to be permanently installed in an aircraft.

ARS 102, 152 consistent with the present teachings may be advantageously used by various types of users. Customer service technicians can use the recorded data to troubleshoot notifications from the field regarding aircraft functionality. Flight data can be analyzed or archived during aircraft manufacture or pre-delivery. Manufacturing personnel can use the system to run functional tests, and engineers can use the data in investigating system anomalies. ARS 152 consistent with the present teachings may be capable of receiving and/or transmitting data on multiple types of avionics data buses, such as: ARINC 429, ARINC 717, CAN, and other data buses. ARS 102, 152 consistent with the present teachings may employ one or more data collection interface boards, which may be connected by LAN and which may interact with additional hardware and/or software interfaces which may be located onboard an aircraft. Consistent with the present teachings, more data and more different types may be recorded in a scalable manner and with full native rate sampling and full instrumentation.

As shown in FIG. 1A, prior art avionics diagnostics network 100 receives data via ARINC 429 channels 104, 106, 108, and 110. For example, each of ARINC 429 channels 104, 106, 108, and 110 may include 20 channels. ARINC 429 data concentrators 112, 114, 116, and 118 are configured to compress data onto fewer channels, for example four channels compressed to one, including data multiplexing. The multiplexing method results in data loss. The concentrated data channels (e.g., A429 1-5 shown in FIG. 1A) are output to ARS 102 for recording of data. The ARINC 429 data concentrators 112, 114, 116, and 118 are ARINC 429 protocol data buses, which are proprietary (ARINC is an acronym for Aeronautical Radio, Incorporated) and at the end of their lifetime necessitating an upgraded data bus architecture.

As shown in FIG. 1B, remotely located data collector 164, 166, 168, 170 are provided with ethernet connectivity pathways 172, 174, 176, 178 to ARS 152, with solid line boxes internal to systems consistent with the present teachings. The ethernet pathways enable data to be multiplexed from the data collectors 164, 166, 168, 170 to ARS 152 without data loss. Data inputs 156, 158, 160, 162 may include but are not limited to ARINC 429, ARINC 717, CAN, and other data buses/protocols, which provides advantages over the prior art avionics diagnostics network 100 which is limited to ARINC429 protocol data buses.

In embodiments, data collectors 164, 166, 168, 170 are data buses dispersed in remote locations (i.e., remotely located from the cockpit or another centralized computing station within the aircraft), which provides shorter wire paths from many input sources (e.g., sensors) leading to an overall reduction in wire weight. For example, data collector 164 may be located in the cockpit and configured to receive cockpit data (e.g., autopilot, GPS); data collector 166 may be located in or near the baggage compartment and configured to receive data from within a baggage compartment (e.g., a pressurization controller); data collector 168 may be located in a right-hand tail cone section and configured to receive data from sensors in the right-hand tail cone; and, data collector 170 may be located in the left-hand tail cone section and configured to receive data from sensors in the left-hand tail cone. Other aircraft locations may be used for housing these or additional data collectors since one of the key features of avionics diagnostics network 150 is a scalable architecture connectable to a virtually unlimited number of data collectors, providing a built-in capability to increase data input sources. Data received by data collectors 164, 166, 168, 170 may be any diagnostics output from other printed circuit boards (PCBs) on the aircraft (e.g., PCBs for a full-authority digital engine controller (FADEC), spoiler monitor, flap monitor, flap control, weight on wheels, dimming control, etc.).

In embodiments, data collectors 164, 166, 168, 170 may be communicatively coupled for data transfer to one another while being indirectly coupled to ARS 152. For example, as depicted in FIG. 1B, data collector 170 in the lefthand tail cone may have ethernet connectivity 178 to data collector 168 in the righthand tail cone only and without data collector 170 having direct ethernet connectivity (or any data communication) with ARS 152. Instead, data collector 170 is communicatively coupled with ARS 152 via ethernet connectivity 178 and 176. In this manner, a plurality of data collectors may be “daisy-chained” together via ethernet connectivity enabling the network of data collectors to be expandable, as further described below in connection with FIG. 3.

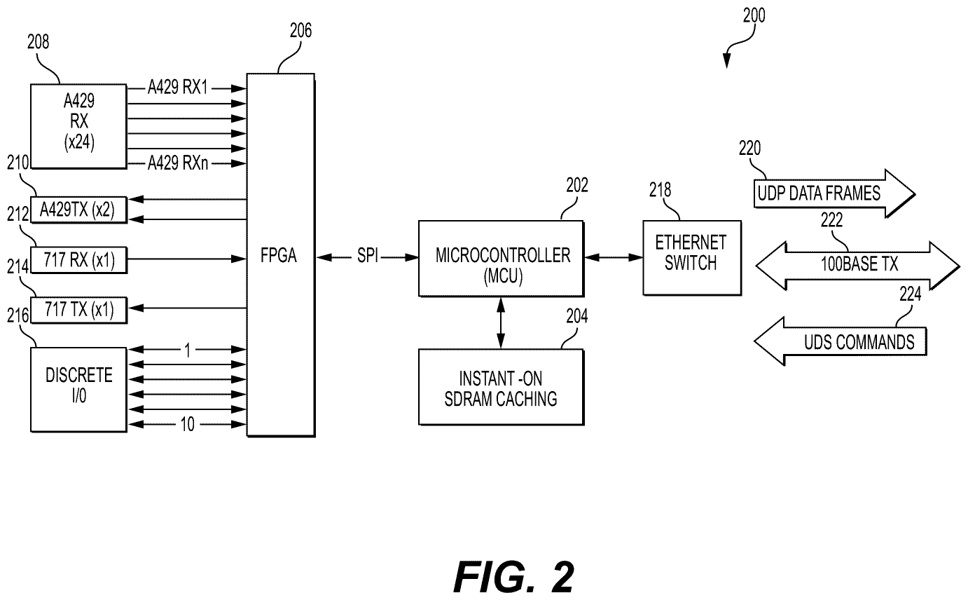

FIG. 2 depicts an architectural block diagram illustrating a microcontroller-based embodiment of a data collection interface 200. Data collection interface 200 is an example of data collectors 164, 166, 168, and 170 of FIG. 1B and may comprise a configurable PCB for example. A field-programmable gate array (FPGA) 206 is communicatively coupled with a microcontroller unit (MCU) 202 via a serial peripheral interface (SPI) 205. FPGA 206 is for example an Intel® MAX 10® FPGA device. MCU 202 is for example an Infineon Technologies 32-bit Arm® Cortex®-M4 Microcontroller. SPI 205 is a serial communication bus, for example Mode 1 SPI with a clock speed of about 16 MHz in which MCU 202 orchestrates communication with FPGA 206 as a subservient peripheral. As depicted in the FIG. 2 embodiment, data inputs/outputs going to/from FPGA 206 may include but are not limited to ARINC 429 data inputs 208, ARINC 429 data outputs 210, ARINC 717 data input 212, ARINC 717 data output 214, and discrete input/outputs 216.

In embodiments, ARS 152 comprises a microprocessor unit 154 (FIG. 3) having a non-real-time operating system that requires a non-trivial amount of time to boot (e.g., fifteen to thirty seconds), which necessitates caching data while ARS 152 is booting. Data collection interface 200 comprises a synchronous dynamic random-access memory (SDRAM) 204 configured to provide instant-on data caching from MCU 202. SDRAM 204 is for example a 16 MB IS42S16800F-7TLI from Integrated Silicon Solution Inc. When ARS 152 is unavailable (e.g., booting), data is cached to SDRAM 204 and later transferred to ARS 152 when available.

Ethernet switch 218 is communicatively coupled to MCU 202. Ethernet switch 218 is for example a KSZ8895MQI from Microchip Technology. Ethernet switch 218 is configured to manage data flow across the ethernet network (e.g., ethernet pathways 172, 174, 176 shown in FIG. 1B) to provide data communication between MCU 202 and ARS 152.

Data provided to ARS 152 is in the form of output User Datagram Protocol (UDP) data frames 220. Commands provided to MCU 202 comprise input UDP commands 224. These data are transmitted between MCU 202 and ARS 152 over ethernet, such as 100Base-TX 222 for example, which is a 100 Mbit/s baseband signaling fast ethernet connection. Alternatively, a 1 Gbps ethernet link may be used.

In embodiments, MCU 202 hosts the controllers to interact with FPGA 206, SDRAM 204 (e.g., SDRAM Controller), and ethernet switch 218 (e.g., Ethernet MAC Controller).

FIG. 3 shows a block diagram of a scalable data collection architecture 300. ARS 152 comprises a microprocessor unit 154 having a non-volatile memory (e.g., a Flash Memory) configured for storing received data and a processor (e.g., a microcontroller) configured for processing software instructions (e.g., applets) as further described is co-pending U.S. Patent Application No. 63/593,225, entitled Configurable Real-Time File Offload Prioritization, and filed on Oct. 25, 2023, the disclosure of which is hereby incorporated by reference in its entirety. The memory of microprocessor unit 154 provides dedicated storage for onboard data recording. Data stored in ARS 152 may be offloaded via a data offload pathway 310, which includes but is not limited to a removable mass storage module, a wired or wireless network connection such as a LAN, 802.11 WiFi, LTE or GSM cellular connection, the Iridium satellite constellation, or through a wired transport mechanism such as universal serial bus (USB) for example.

As shown in FIG. 3, ARS 152 includes its own data collection interface 200A. Additionally, an externally located data collection interface 200B may be communicatively coupled to ARS 152 via ethernet connectivity 222 (e.g., 100BASE-TX described above in connection with FIG. 2). Since each data collection interface 200 has two ethernet ports, an ethernet cable may be used to communicatively couple (i.e., daisy chain) to an additional data collection interface 200. As shown in FIG. 3, data collection interface 200C is daisy chained to data collection interface 200B via ethernet connectivity 222, and data collection interface 200D is daisy chained to data collection interface 200C. Additional data collection interfaces 200 may be added in this manner an arbitrary number of times. Therefore, scalable data collection architecture 300 enables facile expansion of the data collection network while maintaining full native rate sampling and full instrumentation and without multiplexing data.

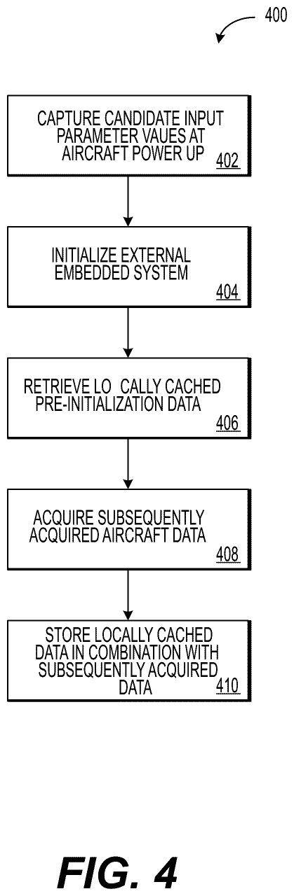

FIG. 4 depicts a flow diagram illustrating an exemplary performant data caching method 400. Method 400 may be performed via data collection interfaces 200A, 200B, 200C, 200D (FIG. 3) prior to microprocessor unit 154 booting up. Specifically, MCU 202 communicates with SDRAM 204 to provide instant-on data caching of data via SDRAM 204 as described above in connection with FIG. 2.

In step 402, candidate input parameter values are captured at aircraft power up, which in some cases corresponds with the startup of an aircraft recording system. In an example of step 410, candidate input parameter values are cached via SDRAM 204 immediately upon supply of main aircraft electrical power or shortly thereafter but before initialization of one or more external embedded systems. In some cases, such captured candidate input parameters may be of critical nature such that failure to capture the candidate input parameters because of delays in initialization of the one or more external embedded systems would result in loss of important aircraft status information as non-capture of such information would otherwise result in a loss of such information.

Examples of data to cache include status information for systems behaving normally as well as faults, including but not limited to FADEC data, avionics data, and data from diagnostics collector PCBs. Other data to cache may be related to a cabin door control and monitor system that assists with opening/closing the cabin door. Such caching may involve writing data to be cached to a volatile memory subsystem. The control and monitor circuitry are energized when the door unlatches and starts to fall open. Various conditions/faults may be cached as this system is coming online (e.g., via signals from proximity switches). Another example includes voltage/bus monitoring. After a main bus is turned on, a variety of systems may still be booting up. The circuit boards that monitor the bus voltages come online immediately upon power on enabling related information to be cached prior to recording by ARS 152. For example, information related to transient current spikes and voltage drops during the power on phase of various systems may be cached. In some embodiments, such a pre-initialization period may take less than approximately 100 milliseconds. In some other embodiments, such a pre-initialization period may take more than approximately one or two seconds.

In step 404, an external embedded system is initialized. In an example of step 404, microprocessor unit 154 has booted up and is initialized. Microprocessor unit 154 comprises an external (i.e., external to data collection interface 200A) embedded system for data recording and storage. In some embodiments, the external embedded system may include a system-on-a-chip or other type of embedded single board microcontroller system. In some cases, this may be a resource constrained single board microcontroller system. In some such embodiments, the external embedded system may include an ARM-based microcontroller system or other microcontroller-based embedded system that for reasons of power, space, or other constraints is loosely-coupled to one or more main aircraft control systems that may begin to receive important information regarding aircraft state prior to a time at which the embedded system may be prepared to begin processing and logging aircraft status information.

In step 406, locally cached pre-initialization data is retrieved. In an example of step 406, pre-initialization data cached in SDRAM 204 is retrieved by microprocessor unit 154. In some embodiments, a loosely-coupled embedded system may be communicatively coupled with ARS 152 by way of one or more conventional (or subsequently discovered) wired or wireless networks, such as mobile telecommunication networks, Ethernet, or IEEE 802.11 (Wi-Fi standards-based) network connections. Such connections may also include any other standards-body-based or defacto standard wired- or wireless-based network connections capable of relaying cached information from an ARS 152 to an external embedded microcontroller system.

In step 408, subsequently-acquired aircraft data are acquired. In an example of step 408, after microprocessor unit 154 has booted, subsequent aircraft data are acquired by ARS 152 and stored via microprocessor unit 154. In some embodiments, such data may be acquired before or during an initialization period associated with the external embedded control system. In such embodiments, caching and synchronization mechanisms consistent with the present teachings enable aircraft event data to be acquired and/or characterized locally such that when the one or more external embedded systems are initialized and ready to process additional events received by the ARS 152, such subsequent events may be prioritized and processed within the context of earlier received aircraft information. Such events may include successful initialization of aircraft components and/or fault conditions such as errors or warnings associated with the aircraft components.

In step 410, locally cached data are stored in combination with subsequently-acquired data. In an example of step 410, microprocessor unit 154 stores locally cached data in combination with subsequently-acquired data. In the context of such an example, such subsequently-acquired data may be interpreted differently in the context of previously acquired (and cached) data. In some such embodiments, previously acquired (and potentially cached) data may be characterized by timestamps or sequence numbers that enable interpretation of previously acquired aircraft data in temporal relation with subsequently-acquired aircraft data.

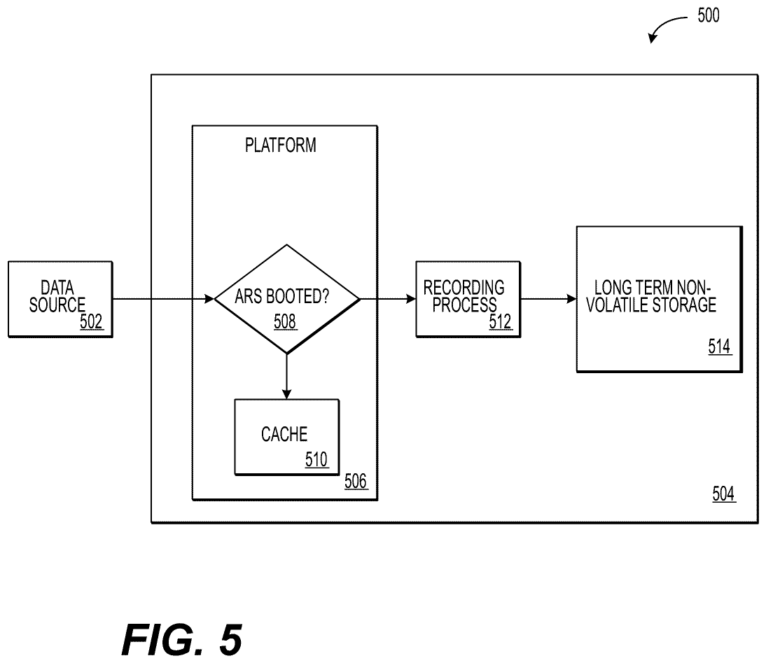

FIG. 5 is an aircraft data recording flow diagram 500 illustrating the flow of aircraft data via an aircraft data recording system that utilizes performant data caching. For example, aircraft data recording flow diagram 500 illustrates the flow of aircraft data being recorded via ARS 152 using performant data caching method 400 in which potentially significant aircraft data may be acquired and/or cached in connection with ARS 152 prior to an external embedded system being able to process and/or synchronize with such aircraft data that may be acquired prior to initialization of the external embedded control system

Aircraft data are provided via a data source 502. For example, the data source 502 may be one or more external data collection interfaces 200B, 200C, 200D. Data storage system 504 includes a data caching platform 506, a data recording process 512, and long term non-volatile data storage 514. Data storage system 504 may be embodied as ARS 152 with platform 506 being embodied as internal data collection interface 200A, for example. As data are received from data source 502, platform 506 determines whether the data storage system 504 has booted in step 508. For example, as data are received from data collection interface 200B, MCU 202 determines whether microprocessor unit 154 has booted. In embodiments, MCU 202 determines whether microprocessor unit 154 is powered on and whether an ethernet connection has been established with microprocessor unit 154. When microprocessor unit 154 is powered on but an ethernet connection has not yet been established, MCU 202 determines that microprocessor unit 154 is booting. While microprocessor unit 154 is booting, data are cached (i.e., stored temporarily) to a cache 510. Cache 510 may be embodied as SDRAM 204, for example. Once microprocessor unit 154 has completed booting (e.g., once an ethernet connection has been established with microprocessor unit 154), then the recording process 512 stores the cached data in long term non-volatile storage 514. Microprocessor unit 154 may perform the recording process 512 to store data in its flash memory, for example. Subsequently-acquired data from data source 502 is then stored via recording process 512 without being cached in cache 510.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An aircraft recording system device providing performant data caching for capturing events during aircraft recording system startup and writing to one or more local caches, the aircraft recording system device comprising:
an aircraft recording system operatively coupled to a data caching interface, wherein the aircraft recording system captures events upon power up that would otherwise be lost during a full aircraft recording system initialization;
one or more data acquisition endpoints associated with the aircraft recording system, capable of locally caching pre-initialization aircraft data within a pre-initialization acquisition period; and
an external embedded data processing system adapted to retrieve, read, and store the locally cached pre-initialization aircraft data in combination with subsequently-acquired aircraft data.

2. The aircraft recording system device of claim 1, wherein the pre-initialization acquisition period is less than approximately 100 milliseconds.

3. The aircraft recording system device of claim 1, wherein the one or more data acquisition endpoints is communicatively coupled with one or more avionics data collectors.

4. The aircraft recording system device of claim 3, wherein the avionics data collectors are connected in a daisy-chain configuration.

5. The aircraft recording system device of claim 4, wherein at least one of the avionics data collectors is remotely located from the aircraft recording system.

6. The aircraft recording system device of claim 4, wherein at least one of the avionics data collectors is configured to receive cockpit data.

7. The aircraft recording system device of claim 1, wherein the external embedded data processing system further comprises one or more non-volatile memory subsystems.

8. A method for providing performant, pre-initialization data caching for capturing faults during aircraft recording system startup and writing to one or more local caches an aircraft recording system device, the method comprising:
capturing one or more candidate input parameter values upon power up of the aircraft recording system, the one or more candidate input parameter values associated with one or more aircraft input parameters corresponding to one or more aircraft system controls, wherein the one or more candidate input parameter values could not be captured prior to a full aircraft recording system initialization;
initializing an external embedded data processing system;
retrieving locally cached pre-initialization aircraft data; and
storing the locally cached pre-initialization aircraft data in combination with subsequently-acquired aircraft data.

9. The method of claim 8, wherein retrieving the locally cached pre-initialization aircraft data further comprises:
receiving by way of an embedded microcontroller system that is communicatively coupled with the aircraft recording system by way of one or more wired or wireless networks configured to relay cached information from the aircraft recording system to the embedded microcontroller system.

10. The method of claim 9, wherein the embedded microcontroller system is a loosely-coupled embedded system adapted to relay cached avionics information from one or more avionics data collectors.

11. The method of claim 8, further comprising acquiring subsequently-acquired aircraft data; and.

12. The method of claim 11, wherein the subsequently-acquired aircraft data comprises subsequently-acquired pre-initialization aircraft data.

13. The method of claim 11, wherein the subsequently-acquired aircraft data comprises subsequently-acquired during-initialization aircraft data.

14. The method of claim 11, wherein the subsequently-acquired aircraft data comprises subsequently-acquired post-initialization aircraft data.

15. One or more non-transitory computer-readable media storing computer-executable instructions that, when executed by a processor, perform a method for providing performant, pre-initialization data caching for capturing faults during aircraft recording system startup and writing to one or more local caches an aircraft recording system (ARS) device, the method comprising:
capturing one or more candidate input parameter values upon power up of the aircraft recording system, the one or more candidate input parameter values associated with one or more aircraft input parameters corresponding to one or more aircraft system controls, wherein the one or more candidate input parameter values could not be captured prior to a full aircraft recording system initialization;
initializing an external embedded data processing system;
retrieve locally cached pre-initialization aircraft data;
acquiring subsequently-acquired aircraft data; and
storing the locally cached pre-initialization aircraft data in combination with the subsequently-acquired aircraft data.

16. The non-transitory computer-readable media of claim 15, wherein the subsequently-acquired aircraft data comprises subsequently-acquired pre-initialization aircraft data.

17. The non-transitory computer-readable media of claim 15, wherein the subsequently-acquired aircraft data comprises subsequently-acquired during-initialization aircraft data.

18. The non-transitory computer-readable media of claim 15, wherein the subsequently-acquired aircraft data comprises subsequently-acquired post-initialization aircraft data.

19. The non-transitory computer-readable media of claim 15, wherein the external embedded data processing system determines whether a network connection has been established with the external embedded data processing system.

20. The non-transitory computer-readable media of claim 19, wherein based on determining that the network connection has been established with the external embedded data processing system, avionics data are temporarily stored in connection with one or more volatile memory devices.
